(19) United States
(12) Patent Application Publication
(10) Pub. No.: US 2025/0309251 A1
(43) Pub. Date: Oct. 2, 2025

(54) POSITIVE ELECTRODE ACTIVE MATERIAL FOR LITHIUM-ION SECONDARY BATTERY, METHOD FOR MANUFACTURING THE SAME, AND LITHIUM-ION SECONDARY BATTERY USING THE SAME

(71) Applicants: HONDA MOTOR CO., LTD., Tokyo (JP); NATIONAL INSTITUTE OF ADVANCED INDUSTRIAL SCIENCE AND TECHNOLOGY, Tokyo (JP)

(72) Inventors: Kazumasa SAKATSUME, Saitama (JP); Takashi HAKARI, Saitama (JP); Kazuki CHIBA, Saitama (JP); Akihisa TANAKA, Saitama (JP); Yoshiyuki MORITA, Saitama (JP); Junji AKIMOTO, Ibaraki (JP); Kunimitsu KATAOKA, Ibaraki (JP); Hideaki NAGAI, Ibaraki (JP)

(21) Appl. No.: 19/083,446

(22) Filed: Mar. 19, 2025

(30) Foreign Application Priority Data
Mar. 30, 2024 (JP) 2024-058343

(51) Int. Cl. H01M 4/505; H01M 4/02; H01M 4/04; H01M 10/0525

(52) U.S. Cl. CPC H01M 4/505; H01M 4/0471; H01M 10/0525; H01M 2004/021; H01M 2004/028

(57) ABSTRACT

A method for manufacturing a positive electrode active material for a lithium-ion secondary battery according to one embodiment of the present invention comprises a step of performing a hydrothermal treatment on a specific NaMnTi-containing oxide having a tunnel structure Pbam in a lithium nitrate aqueous solution to produce a LiMnTi-containing oxide.

This application is based on and claims the benefit of priority from Japanese Patent Application No. 2024-058343, filed on 30 Mar. 2024, the content of which is incorporated herein by reference.

### BACKGROUND OF THE INVENTION

### Field of the Invention

The present invention relates to a positive electrode active material for a lithium-ion secondary battery, a method for manufacturing the positive electrode active material, and a lithium-ion secondary battery using the positive electrode active material.

### Related Art

In recent years, research and development has been conducted on secondary batteries that contribute to energy efficiency to ensure that more people have access to affordable, reliable, sustainable and advanced energy. As a positive electrode active material for lithium-ion secondary batteries, a LiMnTi-containing oxide that is an oxide containing lithium, manganese and titanium, and has a tunnel structure belonging to a space group Pbam (hereinafter referred to as a tunnel structure Pbam) is under consideration. As a method for manufacturing a LiMnTi-containing oxide having a tunnel structure Pbam, a method is known in which Na in a NaMnTi-containing oxide having a tunnel structure Pbam is replaced with Li. As methods for replacing Na with Li, a molten salt method using a molten salt of lithium salt as a lithium source and a solution method using a lithium compound solution as a lithium source are known (see Patent Documents 1 and 2).
Patent Document 1: Japanese Unexamined Patent Application, Publication No. 2005-263583
Patent Document 2: Japanese Unexamined Patent Application, Publication No. 2005-268127

### SUMMARY OF THE INVENTION

By the way, in the technology related to secondary batteries, resource sustainability is one of the problems. LiMnTi-containing oxides do not contain rare metals used as raw materials for the manufacture of positive electrode active materials such as cobalt and nickel, and have attracted attention from the viewpoint of resource sustainability. However, industrial mass synthesis of the LiMnTi-containing oxide is difficult because it requires a step of replacing Na of the NaMnTi-containing oxide with Li and both the molten salt method and the solution method have low productivity.

The present invention has been made in view of the above problems, and aims to provide a positive electrode active material for a lithium-ion secondary battery including a LiMnTi-containing oxide with excellent productivity and which can be mass produced industrially, a method for manufacturing the same, and a lithium-ion secondary battery using the same.

The present inventors have found that a LiMnTi-containing oxide obtained by hydrothermally treating a NaMnTi-containing oxide having a specified composition in an aqueous nitric acid solution has a specified composition and has a high discharge capacity, which led to the completion of the present invention. Therefore, the present invention provides the following.

(1) A positive electrode active material for a lithium-ion secondary battery, having a tunnel structure Pbam, having a composition represented by the following general formula (I), and having a lattice constant in the range of 9.0420 Å or more and 9.1640 Å or less in an a-axis, a lattice constant in the range of 24.294 Å or more and 25.968 Å or less in a b-axis, and a lattice constant in the range of 2.8820 Å or more and 2.8935 Å or less in a c-axis:

LiₐNa_{b}MnₓTi_{y}M_{z}O₂ (I)

wherein, in the above general formula (I), M is at least one element selected from the group consisting of group 2 elements and group 13 elements, a satisfies a relationship of 0.40≤a≤0.50, b satisfies a relationship of 0.01≤b≤0.18, and x, y, and z satisfy relationships of x+y+z=1, 0.50≤x≤1.00, 0<y≤0.50, and 0≤z<0.50.

According to the positive electrode active material for a lithium-ion secondary battery of (1), since it has the above composition, it can be manufactured using a hydrothermal treatment method that is relatively easy to carry out industrially, so that it has excellent productivity and can be industrially mass produced. Further, since the lattice constants of the a-axis, b-axis, and c-axis are within the above ranges, the electric capacity is increased.

(2) The positive electrode active material for a lithium-ion secondary battery according to (1), having a diffraction peak in an X-ray diffraction pattern measured using CuKα as an X-ray source in a range of a diffraction angle 20 of 64.47 degrees or more and 65.57 degrees or less.

According to the positive electrode active material for a lithium-ion secondary battery of (2), an electric capacity is higher because it has the above diffraction peak.

(3) The positive electrode active material for a lithium-ion secondary battery according to (1) or (2), wherein the c-axis lattice constant is in the range of 2.8835 Å or more and 2.8918 Å or less.

According to the positive electrode active material for a lithium-ion secondary battery of (3), since the lattice constant of the c-axis is within the above range, an electric capacity is higher.

(4) The positive electrode active material for a lithium-ion secondary battery according to (3), wherein the c-axis lattice constant is in the range of 2.8850 Å or more and 2.8918 Å or less.

According to the positive electrode active material for a lithium-ion secondary battery of (4), since the lattice constant of the c-axis is within the above range, an electric capacity is even higher.

(5) The positive electrode active material for a lithium-ion secondary battery according to any one of (1) to (4), wherein, in an X-ray diffraction pattern measured using CuKα as an X-ray source, a diffraction peak present in a diffraction angle 20 range of 64 degrees or more and 65 degrees or less has a full width at half maximum of 0.158 degrees or more and 0.186 degrees or less.

According to the positive electrode active material for a lithium-ion secondary battery of (5), since the full width at half maximum of the above diffraction peak is within the above range, and the crystallinity is high, an electric capacity is higher.

(6) The positive electrode active material for a lithium-ion secondary battery according to any one of (1) to (5), wherein, in an X-ray diffraction pattern measured using CuKα as an X-ray source, a diffraction peak present in a diffraction angle 20 range of 61 degrees or more and 62 degrees or less has a full width at half maximum of 0.142 degrees or more and 0.280 degrees or less.

According to the positive electrode active material for a lithium-ion secondary battery of (6), since the full width at half maximum of the above diffraction peak is within the above range, and e the crystallinity is even higher, an electric capacity is even higher.

(7) A method for manufacturing the positive electrode active material for a lithium-ion secondary battery according to any one of (1) to (6), the method comprising a step of performing a hydrothermal treatment on a NaMnTi-containing oxide in a lithium nitrate aqueous solution to produce a LiMnTi-containing oxide, wherein the NaMnTi-containing oxide has a tunnel structure Pbam and is represented by the following general formula (II):

Na_{c}MnₓTi_{y}M_{z}O₂ (II)

wherein, in the above general formula (II), M is at least one element selected from the group consisting of group 2 elements and group 13 elements, c satisfies a relationship of 0.40≤c 0.50, and x, y, and z satisfy relationships of x+y+z=1, 0.50≤x≤1.00, 0<y≤0.50, and 0≤z<0.50.

According to the method for manufacturing the positive electrode active material for a lithium-ion secondary battery of (7), since the NaMnTi-containing oxide of the general formula (II) above is hydrothermally treated in a lithium nitrate aqueous solution, the positive electrode active material for a secondary battery of the present embodiment can be manufactured with high efficiency.

(8) The method for manufacturing the positive electrode active material for a lithium-ion secondary battery according to (7), wherein a treatment temperature of the hydrothermal treatment is in the range of 80° C. or more and 220° C. or less.

According to the method for manufacturing the positive electrode active material for a lithium-ion secondary battery of (8), the above-described positive electrode active material for a lithium-ion secondary battery can be reliably produced.

(9) The method for manufacturing the positive electrode active material for a lithium-ion secondary battery according to (8), wherein the treatment temperature of the hydrothermal treatment is in the range of 150° C. or more and 220° C. or less.

According to the method for manufacturing the positive electrode active material for a lithium-ion secondary battery of (9), the above-described positive electrode active material for a lithium-ion secondary battery can be produced with even greater reliability.

(10) The method for manufacturing the positive electrode active material for a lithium-ion secondary battery according to (9), wherein the treatment temperature of the hydrothermal treatment is in the range of 190° C. or more and 220° C. or less.

According to the method for manufacturing the positive electrode active material for a lithium-ion secondary battery of (10), a positive electrode active material for a lithium-ion secondary battery with high crystallinity can be produced.

(11) The method for manufacturing the positive electrode active material for a lithium-ion secondary battery according to any one of (7) to (10), further comprising a step of heating the LiMnTi-containing oxide at a temperature in the range of 200° C. or more and 320° C. or less.

According to the method for the positive electrode active material for a lithium-ion secondary battery of (11), a positive electrode active material for a lithium-ion secondary battery with even higher crystallinity can be industrially advantageously produced.

(12) A lithium-ion secondary battery comprising a positive electrode material mixture layer including the positive electrode active material for a lithium-ion secondary battery according to any one of (1) to (6).

According to the lithium-ion secondary battery of (12), since it contains the positive electrode active material for a lithium-ion secondary battery described above, an electric capacity per mass is high.

According to the present invention, a positive electrode active material for a lithium-ion secondary battery containing a LiMnTi-containing oxide with excellent productivity and which can be mass produced industrially, a method for manufacturing the same, and a lithium-ion secondary battery using the same can be provided.

### BRIEF DESCRIPTION OF THE DRAWINGS

FIG. 1 is X-ray diffraction patterns of the LiMnTi-containing oxide powder obtained in Examples 1 to 4;

FIG. 2 is X-ray diffraction patterns of the LiMnTi-containing oxide powder obtained in Examples 5 to 8;

FIG. 3 is an X-ray diffraction pattern of the LiMnTi-containing oxide powder obtained in Comparative Example 1;

FIG. 4 is X-ray diffraction patterns of the LiMnTi-containing oxide powder after annealing treatment obtained in Examples 9 to 12;

FIG. 5 is X-ray diffraction patterns of the LiMnTi-containing oxide powder after annealing treatment obtained in Examples 13 to 16; and

FIG. 6 is X-ray diffraction patterns of the LiMnTi-containing oxide powder after annealing treatment obtained in Examples 17 to 19.

### DETAILED DESCRIPTION OF THE INVENTION

Hereinafter, embodiments of the present invention will be described. However, the following embodiments illustrate the present invention, and the present invention is not limited to the following embodiments.

The positive electrode active material for the lithium-ion secondary batteries of the present embodiment is a LiMnTi-containing oxide containing a lithium (Li), manganese (Mn), and titanium (Ti), and having a tunnel structure Pbam. The LiMnTi-containing oxide may further include at least one element selected from the group consisting of group 2 elements and group 13 elements. The LiMnTi-containing oxide is represented by the following general formula (I).

LiₐNa_{b}MnₓTi_{y}M_{z}O₂ (I)

In the above general formula (I), M is at least one element selected from the group consisting of group 2 elements and group 13 elements, a satisfies a relationship of 0.40≤a≤0.50, b satisfies a relationship of 0.01≤b≤0.25, and x, y, and z satisfy relationships of x+y+z=1, 0.50≤x≤1.00, 0<y≤0.50, and 0≤z<0.50. b is preferably 0.01≤b≤0.20, more preferably 0.01≤b≤0.10, and still more preferably 0.01≤b≤0.03.

In the general formula (I), examples of the group 2 elements represented by M include magnesium and calcium. The group 13 elements represented by M include aluminum. These elements may be used alone or in combination of two or more.

In an X-ray diffraction pattern measured using CuKα as an X-ray source, the LiMnTi-containing oxide may have a peak in the range of a diffraction angle 20 of 64.47 degrees or more and 65.57 degrees or less. LiMnTi-containing oxide with this diffraction peak has a higher electrical capacity.

The LiMnTi-containing oxide is within the range where the lattice constant of the a-axis is 9.0420 Å or more and 9.1640 Å or less, the lattice constant of the b-axis is 24.294 Å or more and 25.968 Å or less, and the lattice constant of the c-axis is 2.8820 Å or more and 2.8935 Å or less. The lattice constant of the a-axis is preferably in the range of 9.0620 Å or more and 9.0930 Å or less. The lattice constant of the b-axis is preferably in the range of 24.294 Å or more and 24.611 Å or less, more preferably in the range of 24.294 Å or more and 24.503 Å or less. The lattice constant of the c-axis is preferably in the range of 2.8835 Å or more and 2.8918 Å, more preferably in the range of 2.8850 Å or more and 2.8918 Å or less. When the lattice constants of the a-axis, b-axis and c-axis are within the above range, the electric capacitance of the LiMnTi-containing oxide becomes higher.

In the X-ray diffraction pattern measured using CuKα as an X-ray source of the LiMnTi-containing oxide, the full width at half maximum of the diffraction peak present in the diffraction angle 20 range of 64 degrees or more and 65 degrees or less may be 0.158 degrees or more and 0.186 degrees or less. Since the LiMnTi-containing oxide having a full width at half maximum of this diffraction peak within the above range has high crystallinity, the electric capacity is further increased.

In the X-ray diffraction pattern measured using CuKα as an X-ray source, the full width at half maximum of the diffraction peak present in the diffraction angle 20 range of 61 degrees or more and 62 degrees or less may be 0.142 degrees or more and 0.280 degrees or less. Since the LiMnTi-containing oxide having a full width at half maximum of this diffraction peak within the above range has even higher crystallinity, the electric capacity is still further increased.

The positive electrode active material for lithium-ion secondary batteries of the present embodiment can be produced, for example, by a method including a step of performing a hydrothermal treatment on a NaMnTi-containing oxide having a tunnel structure Pbam in a lithium nitrate aqueous solution to produce a LiMnTi-containing oxide. The NaMnTi-containing oxide can use an oxide represented by the following general formula (II).

Na_{c}mnₓTi_{y}M_{z}O₂ (II)

In the above general formula (II), M is at least one element selected from the group consisting of group 2 elements and group 13 elements, c satisfies a relationship of 0.40≤c≤0.50, and x, y, and z satisfy relationships of x+y+z=1, 0.50≤x≤1.00, 0<y≤0.50, and 0≤z<0.50.

Nitric acid concentration of the lithium nitrate aqueous solution is, for example, 100 g/L or more. The lithium nitrate aqueous solution may be saturated aqueous solution. The amount of NaMnTi-containing oxide in the lithium nitrate aqueous solution is an amount in which the amount of Li ranges from 10 to 50 mol, for example, when the molar amount of NaMnTi-containing oxide is 1 mol.

The treatment temperature of the hydrothermal treatment is, for example, in the range of 80° C. or more and 220° C. or less, preferably 110° C. or more, more preferably 150° C. or more, particularly preferably 190° C. or more. The above-described positive electrode active material for lithium-ion secondary batteries can be reliably manufactured by the treatment temperature being within the above-described range. In particular, a high crystallinity LiMnTi-containing oxide can be produced when the processing temperature is 190° C. or more. The processing time of the hydrothermal treatment varies depending on conditions such as the Li concentration of the lithium nitrate aqueous solution, the concentration of the NaMnTi-containing oxide in the lithium nitrate aqueous solution, the volume of the reaction vessel, etc., but is within a range of, for example, 1 to 30 hours.

The LiMnTi-containing oxide produced by the hydrothermal treatment may be washed and dried. Wash may be performed by water washing. Water washing the LiMnTi-containing oxide removes Na replaced with Li and unreacted lithium nitrate. The drying method is not particularly limited, and various methods used as drying methods for inorganic material such as heat drying method, vacuum drying method, and spray drying method can be used.

The positive electrode active material for lithium-ion secondary batteries of the present embodiment can be used as a positive electrode active material of lithium-ion secondary batteries. A lithium-ion secondary battery has, for example, a positive electrode, a negative electrode, an electrolyte solution, a separator arranged between the positive electrode and the negative electrode, and an outer casing that accommodates these. A solid electrolyte may be used instead of the electrolyte solution.

The positive electrode includes a positive electrode current collector and a positive electrode active material layer formed on the surface of the positive electrode current collector. The positive electrode active material layer includes the positive electrode active material for the lithium-ion secondary batteries of the present embodiment. The positive electrode active material layer may include a conductive additive and a binder. Since the positive electrode active material for the secondary batteries of the present embodiment is chemically stable, the conductive additive and the binder are not particularly limited, and a known one used in the positive electrode active material layer of lithium-ion secondary batteries can be used. Further, the positive electrode current collector is not particularly limited, and a known one used in the positive electrode current collector of lithium-ion secondary batteries such as an aluminum foil can be used.

As the negative electrode, a laminated body including a negative electrode current collector and a negative electrode active material layer formed on the surface of the negative electrode current collector can be used. The negative electrode active material layer includes a negative electrode active material. As the negative electrode active material, lithium metal, a material capable of absorbing and releasing lithium, a metal or a metalloid forming an alloy with lithium can be used. Examples of materials capable of absorbing and releasing lithium include lithium transition metal oxide such as lithium titanate, transition metal oxide such as TiO₂, Nb₂O₃, and WO₃, SiO, metal sulfide, metal nitride, and carbon materials such as artificial graphite, natural graphite, graphite, soft carbon, and hard carbon. Examples of metals or metalloids that form an alloy with lithium include Mg, Si, Au, Ag, In, Ge, Sn, Pb, Al, and Zn, etc. When the negative electrode active material is in powder form, the negative electrode active material layer may include a conductive additive and a binder. The conductive additive and the binder are not particularly limited, and a known one used in the negative electrode active material layer of lithium-ion secondary batteries can be used. Further, the negative electrode current collector is not particularly limited, and a known material used in the negative electrode current collector of lithium-ion secondary batteries such as a copper foil can be used.

An electrolyte solution includes an organic solvent and an electrolyte. As the organic solvent, for example, cyclic carbonate, chain carbonate, cyclic ether, chain ether, hydrofluoroether, aromatic ether, sulfone, cyclic ester, chain carboxylic acid ester, and nitrile can be used. Examples of cyclic carbonates include ethylene carbonate, propylene carbonate, vinylene carbonate, and fluoroethylene carbonate, etc. Examples of chain carbonates include dimethyl carbonate, diethyl carbonate, and ethyl methyl carbonate, etc. Examples of cyclic ethers include tetrahydrofuran, 2-methyltetrahydrofuran, tetrahydropyran, 1,3-dioxolane, and 4-methyl-1,3-dioxolane, etc. Examples of chain ethers include 1,2-dimethoxyethane, 1,2-diethoxyethane, ethoxymethoxyethane, and diethyl ether, etc. Examples of hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane, etc. Example of aromatic ether includes anisole. Examples of sulfones include sulfolane and methyl sulfolane, etc. Examples of cyclic esters include γ-butyrolactone, etc. Examples of chain carboxylic acid esters include acetate esters, butyrate esters, and propionate esters, etc. Examples of nitriles include acetonitrile and propionitrile, etc. As for the organic solvent, one type may be used either alone or in combination with two or more.

The electrolyte is a source of lithium ions, which are charge transfer mediums and include lithium salts. Examples of lithium salts include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈, etc. As for the lithium salt, one type may be used either alone or in combination with two or more.

As the solid electrolyte, for example, a sulfide solid electrolyte, an oxide solid electrolyte, a nitride solid electrolyte, a halide solid electrolyte, and the like can be used. Examples of sulfide solid electrolytes include Li₂S—P₂S₅, Li₂S—P₂S₅—LiI, etc. Examples of the oxide solid electrolyte include NASICON type oxide, garnet type oxide, perovskite type oxide, etc. Examples of NASICON type oxides include oxides containing Li, Al, Ti, P, and O (e.g., Li_{1.5}Al_{0.5}Ti_{1.5}(PO₄)₃).

Examples of garnet type oxides include oxides containing Li, La, Zr, and O (e.g., Li₇La₃Zr₂O₁₂). Examples of perovskite type oxides include oxides containing Li, La, Ti, and O (e.g., LiLaTiO₃).

The separator is not particularly limited, for example, a porous sheet or a nonwoven fabric sheet can be used. Examples of materials for the porous sheet include polyolefins such as polyethylene and polypropylene, aramid, polyimide, and fluorine resins, etc. Examples of materials for the nonwoven fabric sheet include fiberglass, cellulose fibers, etc.

The outer casing is not particularly limited, and a known outer casing used in lithium-ion secondary batteries, such as metal container or laminated film container, and the like can be used.

According to the positive electrode active material for lithium-ion secondary batteries of the present embodiment, since it has the composition of the above general formula (I), it can be manufactured using a hydrothermal treatment method that is relatively easy to carry out industrially, so that it is excellent in productivity and can be mass produced industrially.

According to the method for manufacturing the positive electrode active material for lithium-ion secondary batteries according to the present embodiment, the NaMnTi-containing oxide of the above general formula (II) is hydrothermally treated in a lithium nitrate aqueous solution, so that the positive electrode active material for secondary batteries according to the present embodiment can be manufactured with high efficiency.

According to the lithium-ion secondary battery of the present embodiment, the positive electrode active material for lithium-ion secondary batteries of the present embodiment is high in productivity.

### EXAMPLES

### Example 1

### Preparation of NaMnTi-Containing Oxide Powder

Na₂CO₃, Mn₂O₃, and TiO₂ were weighed so that the total molar amount of Mn and Ti was 1 mol, the molar amount of Na (Na/(Mn+Ti)) was 0.5 mol, the molar amount of Ti (Ti/(Mn+Ti)) was 0.50 mol, and the total mass was 1.0 g. The weighed Na₂CO₃, Mn₂O₃, and TiO₂ were mixed with a mortar and pestle. The resulting raw material mixture was placed in an alumina crucible and calcined under atmospheric conditions at a calcinating temperature of 1000° C. for 12 hours. After calcination, the obtained calcined product was pulverized with a mortar and pestle. The X-ray diffraction pattern of the obtained calcined product powder was measured and it was confirmed that the obtained calcined product powder was a NaMnTi oxide powder having a tunnel structure.

### Preparation of LiMnTi-Containing Oxide Powder

25.00 g of LiNO₃ and 50 mL of water were placed in a hydrothermal reaction vessel and stirred to dissolve the LiNO₃, resulting in the preparation of a LiNO₃ solution. Then, 1.0 g of NaMnTi oxide powder obtained above was added to the LiNO₃ solution and stirred to obtain a dispersion liquid of the NaMnTi oxide powder dispersed in the LiNO₃ solution. The hydrothermal reaction vessel was then sealed and the sealed hydrothermal reaction vessel was placed in a thermostatic bath and heated in the atmosphere at a heating temperature of 80° C. for 24 hours to hydrothermally treat the NaMnTi oxide powder. After heating, hydrothermal treated powder (LiMnTi-containing oxide powder) was recovered from the hydrothermal reaction vessel. After washing the recovered LiMnTi-containing oxide powder with water, three operations were performed to remove moisture by centrifugation. The moisture removed LiMnTi-containing oxide powder was placed on a petri dish and dried in vacuo at a temperature of 100° C. for 6 hours. After drying, the LiMnTi-containing oxide powder was pulverized using mortar and pestle.

### Examples 2 to 8

A LiMnTi-containing oxide powder was manufactured in the same manner as in Example 1 except that the hydrothermal treatment temperature was 100° C. for Example 2, 120° C. for Example 3, 140° C. for Example 4, 160° C. for Example 5, 180° C. for Example 6, 200° C. for Example 7, and 220° C. for Example 8.

### Comparative Example 1

The LiMnTi-containing oxide powder was manufactured in the same manner as in Example 1, except that the Na of the NaMnTi-containing oxide powder was replaced with Li using the molten salt method. The replacement conditions were as follows. As the molten salt, a molten salt including lithium nitrate and lithium chloride in a molar ratio of 88:12 was used. The ratio of the molten salt to NaMnTi-containing oxide powder was 20:1 in a molar ratio of Li to Na. The replacement time was set to 10 hours.

### Evaluation

For the LiMnTi-containing oxide powder obtained in Examples 1 to 8 and Comparative Example 1, the chemical composition, X-ray diffraction pattern, lattice constant, full width at half maximum (FWHM), and charge-discharge characteristics were evaluated by the following methods.

### Chemical Composition

The sample was dissolved in acid. The content of Li, Na, Mn, Ti, and Al in the obtained solution was measured using an ICP luminescence spectrometer. The obtained Li, Na, Mn, Ti, and Al content was converted to a molar amount of 1 mol of the total amount of Mn, Ti, and Al. The results are shown in Table 1 below with the hydrothermal treatment temperature.

### X-Ray Diffraction Pattern

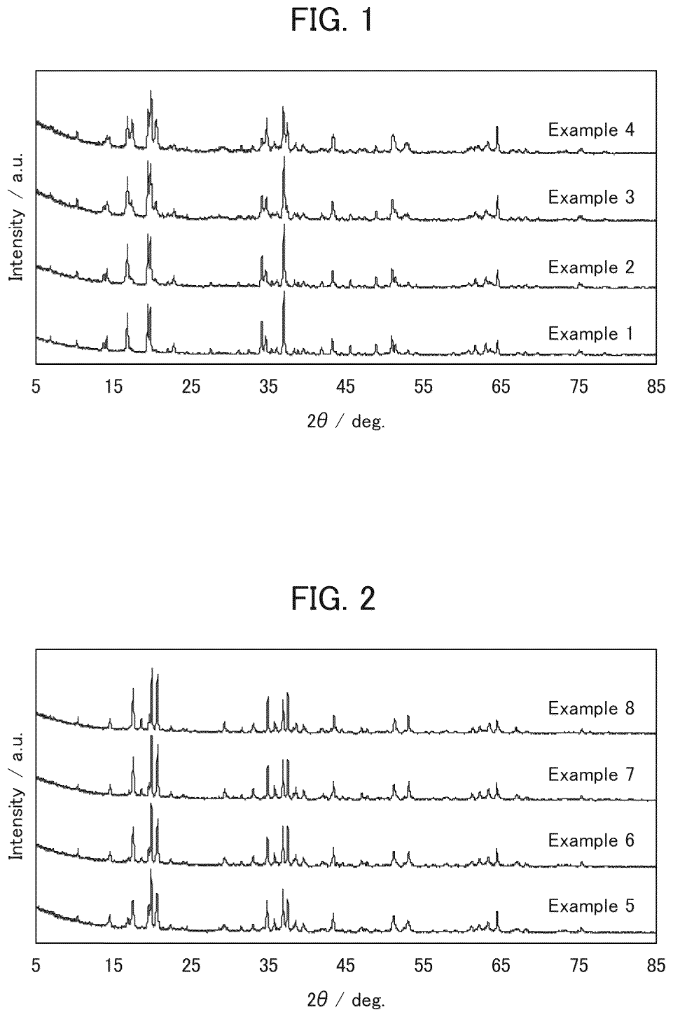

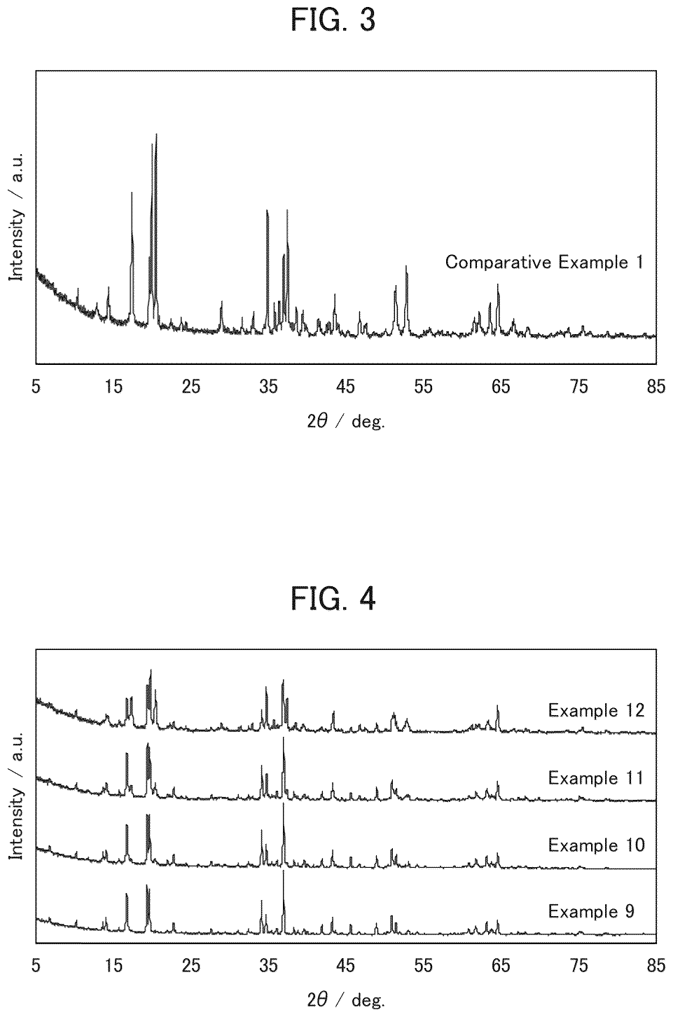

The X-ray diffraction pattern was measured under the following conditions. The results are shown in FIGS. 1 to 3.
Measurement apparatus: RINT-2550V, manufactured by Rigaku Co., Ltd.
X-ray source: CuKα
X-ray output: 40 kV, 200 mA
Measurement conditions: 1.0 s, 0.03 deg interval

### Lattice Constant

The lattice constants of a-axis, b-axis and c-axis were measured using the above X-ray diffraction pattern. The lattice constant was determined by the least squares method using each index of the diffraction peak due to the tunnel structure Pbam extracted from the X-ray diffraction pattern and its interfacial spacing. The results are shown in Table 2 below.

### Full Width at Half Maximum (FWHM)

From the above X-ray diffraction pattern, a diffraction peak with a diffraction angle 20 in the range of 61 degrees or more and 62 degrees or less (diffraction peak of 61 to 62 degrees) and a diffraction peak with a diffraction angle 20 in the range of 64 degrees or more and 65 degrees or less (diffraction peak of 64 to 65 degrees) were extracted. A full width at half maximum (FWHM) of the extracted peak was measured. The results are shown in Table 2 below.

### Charge-Discharge Characteristics

5 mg of sample was mixed with 5 mg of acetylene black as conductive material and 1 mg of PTFE as binder. The resulting mixture was molded into a sheet, crimped onto an Al mesh as a working electrode, and a counter electrode was a lithium metal foil. The working electrode and the counter electrode were immersed in an electrolyte solution in which LiPF₆ was dissolved in an EC+DMC solvent to prepare a two-electrode cell.

Charge-discharge tests were performed using two-electrode cell. The conditions of the charge-discharge tests were that the current density (per sample) was 10 mA/g, the potential range was 2.0 to 4.8 V, and the charging was constant current-constant voltage charging (until 2 hours have passed). The charge-discharge test was performed under an environment of 25° C. The initial (first cycle) discharge capacity is shown in Table 2 below.

TABLE 1

| | Hydrothermal | | | | |
|---|---|---|---|---|---|
| | treatment | | | | |
| | temperature | Composition of LiMnTi oxide (mol) | | | |
| | (° C.) | Li | Na | Mn | Ti |
| Example 1 | 80 | 0.20 | 0.24 | 0.51 | 0.49 |
| Example 2 | 100 | 0.22 | 0.21 | 0.51 | 0.49 |
| Example 3 | 120 | 0.26 | 0.18 | 0.51 | 0.49 |
| Example 4 | 140 | 0.27 | 0.12 | 0.51 | 0.49 |
| Example 5 | 160 | 0.33 | 0.07 | 0.51 | 0.49 |
| Example 6 | 180 | 0.36 | 0.04 | 0.51 | 0.49 |
| Example 7 | 200 | 0.39 | 0.02 | 0.51 | 0.49 |
| Example 8 | 220 | 0.41 | 0.01 | 0.52 | 0.48 |
| Comparative | — | 0.49 | 0.02 | 0.51 | 0.49 |
| Example 1 | | | | | |

TABLE 2

| | | | | | | | Full width at half maximum (FWHM) | | |
|---|---|---|---|---|---|---|---|---|---|
| | Lattice constant (Å) | | | | | | Diffraction | Diffraction | |
| | a-axis | | b-axis | | c-axis | | peak of 61 to | peak of 64 to | Discharge |
| | Average | Error | Average | Error | Average | Error | 62 degrees | 65 degrees | capacity |
| | value | bar | value | bar | value | bar | (degrees) | (degrees) | (mAh/g) |
| Example 1 | 9.1620 | 2 | 25.942 | 19 | 2.8854 | 5 | 0.270 | 0.206 | 104 |
| Example 2 | 9.1640 | 3 | 25.968 | 8 | 2.8866 | 9 | 0.250 | 0.186 | 106 |
| Example 3 | 9.0810 | 4 | 24.939 | 13 | 2.8890 | 13 | 0.610 | 0.202 | 105 |
| Example 4 | 9.0720 | 4 | 24.611 | 11 | 2.8849 | 12 | 1.350 | 0.173 | 109 |
| Example 5 | 9.0930 | 17 | 24.377 | 5 | 2.8910 | 4 | 0.370 | 0.179 | 117 |
| Example 6 | 9.0880 | 2 | 24.355 | 7 | 2.8918 | 7 | 0.390 | 0.165 | 127 |
| Example 7 | 9.0790 | 2 | 24.346 | 6 | 2.8918 | 6 | 0.200 | 0.168 | 126 |
| Example 8 | 9.0676 | 14 | 24.434 | 4 | 2.8910 | 3 | 0.229 | 0.180 | 131 |
| Comparative | 9.0187 | 16 | 24.637 | 4 | 2.8780 | 5 | 0.27 | 0.226 | 145 |
| Example 1 | | | | | | | | | |

From the X-ray diffraction pattern of FIGS. 2 to 4, it was confirmed that all of the LiMnTi-containing oxide powder obtained in Examples 1 to 8 have the tunnel structure Pbam. From the results of Table 1, it can be seen that as the hydrothermal treatment temperature increases, the Li content of the LiMnTi-containing oxide powder increases, i.e. as the heat treatment temperature increases, the replacement of Na and Li tends to proceed. Further, from the results of Table 2, it can be seen that as the hydrothermal treatment temperature increases, the lattice constants of the a-axis and b-axis decrease, the c-axis increases, and the full width at half maximum tends to decrease. Further, it can be seen that all of the LiMnTi-containing oxide powders obtained in Examples 1 to 8 are capable of absorbing and releasing Li, and the discharge capacity increases as the hydrothermal treatment temperature increases.

### Example 9

### Annealing Treatment of LiMnTi-Containing Oxide Powder

The LiMnTi-containing oxide powder obtained in Example 1 was placed in an alumina crucible and subjected to annealing by calcining in atmosphere at an annealing temperature of 270° C. for a calcining time of 12 hours. After annealing, the obtained calcined product was pulverized with a mortar and pestle.

### Examples 10 to 19

An annealing treatment was performed in the same manner as in Example 9, except that using the LiMnTi-containing oxide powder shown in Table 3 below and setting the annealing temperature to the temperature shown in Table 3 below.

### Evaluation

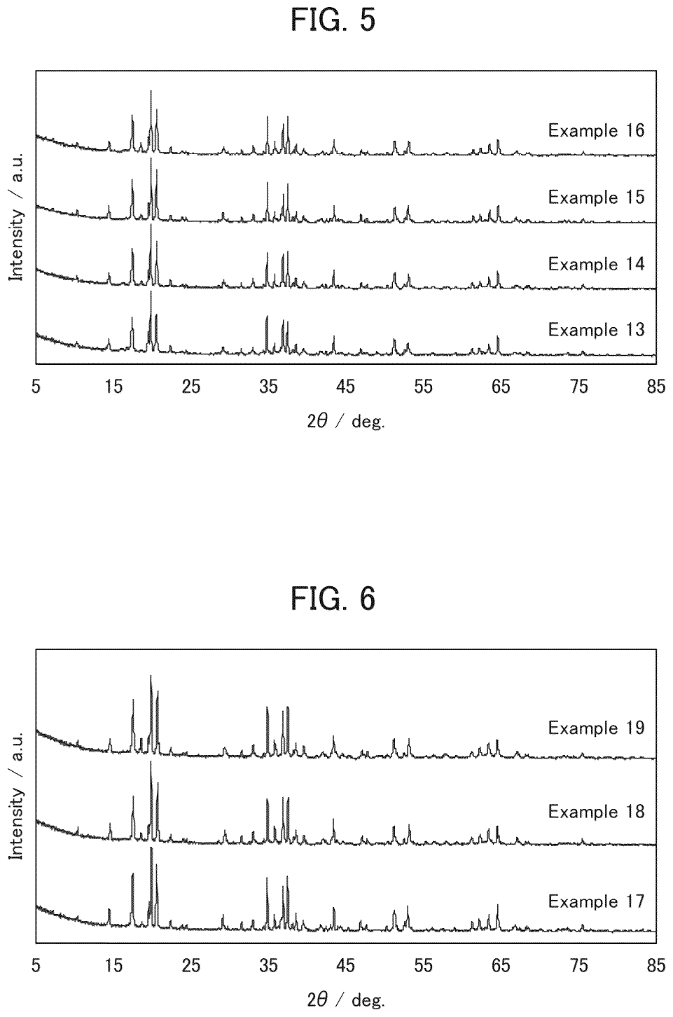

For the LiMnTi-containing oxide powders obtained in Examples 1 to 8, X-ray diffraction pattern, lattice constant, full width at half maximum (FWHM), and charge-discharge characteristics were evaluated by the above methods. X-ray diffraction patterns are shown in FIGS. 4 to 8. The lattice constants, full width at half maximum (FWHM), and discharge capacity are shown in Table 3 below.

TABLE 3

| | | | | | | | | | Full width at half maximum (FWHM) | | |
|---|---|---|---|---|---|---|---|---|---|---|---|
| | Type of | | Lattice constant (Å) | | | | | | Diffraction | Diffraction | |
| | LiMnTi | Annealing | a-axis | | b-axis | | c-axis | | peak of 61 to | peak of 64 to | Discharge |
| | oxide | temperature | Average | Error | Average | Error | Average | Error | 62 degrees | 65 degrees | capacity |
| | powder | (° C.) | value | bar | value | bar | value | bar | (degrees) | (degrees) | (mAh/g) |
| Example 9 | Example 1 | 270 | 9.1498 | 19 | 25.836 | 17 | 2.8860 | 2 | 0.221 | 0.180 | 104 |
| Example 10 | Example 2 | 270 | 9.0860 | 7 | 24.970 | 2 | 2.8923 | 19 | 0.200 | 0.178 | 108 |
| Example 11 | Example 3 | 270 | 9.0420 | 4 | 24.796 | 12 | 2.8847 | 14 | 0.180 | 0.186 | 109 |
| Example 12 | Example 4 | 270 | 9.0660 | 3 | 24.567 | 8 | 2.8835 | 9 | 0.142 | 0.184 | 115 |
| Example 13 | Example 5 | 270 | 9.0760 | 14 | 24.478 | 4 | 2.8856 | 3 | 0.185 | 0.166 | 121 |
| Example 14 | Example 6 | 270 | 9.0756 | 13 | 24.392 | 4 | 2.8853 | 3 | 0.186 | 0.168 | 128 |
| Example 15 | Example 7 | 270 | 9.0676 | 13 | 24.503 | 4 | 2.8879 | 3 | 0.169 | 0.172 | 139 |
| Example 16 | Example 8 | 270 | 9.0620 | 3 | 24.411 | 7 | 2.8850 | 7 | 0.216 | 0.171 | 137 |
| Example 17 | Example 6 | 300 | 9.0681 | 12 | 24.501 | 3 | 2.8858 | 3 | 0.184 | 0.176 | 130 |
| Example 18 | Example 7 | 240 | 9.0810 | 2 | 24.294 | 6 | 2.8857 | 6 | 0.210 | 0.158 | 139 |
| Example 19 | Example 8 | 210 | 9.0814 | 14 | 24.326 | 4 | 2.8883 | 4 | 0.280 | 0.174 | 137 |

From the results of Table 3, it can be seen that the discharge capacity of the LiMnTi-containing oxide powder after annealing treatment tends to increase as the treatment temperature increases when the NaMnTi-containing oxide powder is hydrothermally treated to produce the LiMnTi-containing oxide powder. Therefore, from the results of this example, it was confirmed that it is possible to obtain the LiMnTi-containing oxide powder with high electric capacity by performing the hydrothermal treatment and annealing treatment.

What is claimed is:

1. A positive electrode active material for a lithium-ion secondary battery, having a tunnel structure Pbam, having a composition represented by the following general formula (I), and having a lattice constant in the range of 9.0420 Å or more and 9.1640 Å or less in an a-axis,
a lattice constant in the range of 24.294 Å or more and 25.968 Å or less in a b-axis, and a lattice constant in the range of 2.8820 Å or more and 2.8935 Å or less in a c-axis:
LiₐNa_{b}MnₓTi_{y}M_{z}O₂ (I)
wherein, in the above general formula (I), M is at least one element selected from the group consisting of group 2 elements and group 13 elements, a satisfies a relationship of 0.40≤a≤0.50, b satisfies a relationship of 0.01≤b≤0.25, and x, y, and z satisfy relationships of x+y+z=1, 0.50≤x≤1.00, 0<y≤0.50, and 0≤z<0.50.

2. The positive electrode active material for a lithium-ion secondary battery according to claim 1, having a diffraction peak in an X-ray diffraction pattern measured using CuKα as an X-ray source, in a range of a diffraction angle 20 of 64.47 degrees or more and 65.57 degrees or less.

3. The positive electrode active material for a lithium-ion secondary battery according to claim 1, wherein the c-axis lattice constant is in the range of 2.8835 Å or more and 2.8918 Å or less.

4. The positive electrode active material for a lithium-ion secondary battery according to claim 1, wherein the c-axis lattice constant is in the range of 2.8850 Å or more and 2.8918 Å or less.

5. The positive electrode active material for a lithium-ion secondary battery according to claim 1, wherein, in an X-ray diffraction pattern measured using CuKα as an X-ray source, a diffraction peak present in a diffraction angle 20 range of 64 degrees or more and 65 degrees or less has a full width at half maximum of 0.158 degrees or more and 0.186 degrees or less.

6. The positive electrode active material for a lithium-ion secondary battery according to claim 1, wherein, in an X-ray diffraction pattern measured using CuKα as an X-ray source, a diffraction peak present in a diffraction angle 20 range of 61 degrees or more and 62 degrees or less has a full width at half maximum of 0.142 degrees or more and 0.280 degrees or less.

7. A method for manufacturing the positive electrode active material for a lithium-ion secondary battery according to claim 1,
the method comprising a step of performing a hydrothermal treatment on a NaMnTi-containing oxide in a lithium nitrate aqueous solution to produce a LiMnTi-containing oxide, wherein the NaMnTi-containing oxide has a tunnel structure Pbam and is represented by the following general formula (II):
Na_{c}MnₓTi_{y}M_{z}O₂ (II)
wherein, in the above general formula (II), M is at least one element selected from the group consisting of group 2 elements and group 13 elements, c satisfies a relationship of 0.40≤c≤0.50, and x, y, and z satisfy relationships of x+y+z=1, 0.50≤x≤1.00, 0<y≤0.50, and 0≤z<0.50.

8. The method for manufacturing the positive electrode active material for a lithium-ion secondary battery according to claim 7, wherein a treatment temperature of the hydrothermal treatment is in the range of 80° C. or more and 220° C. or less.

9. The method for manufacturing the positive electrode active material for a lithium-ion secondary battery according to claim 8, wherein the treatment temperature of the hydrothermal treatment is in the range of 150° C. or more and 220° C. or less.

10. The method for manufacturing the positive electrode active material for a lithium-ion secondary battery according to claim 9, wherein the treatment temperature of the hydrothermal treatment is in the range of 190° C. or more and 220° C. or less.

11. The method for manufacturing the positive electrode active material for a lithium-ion secondary battery according to claim 7, further comprising a step of heating the LiMnTi-containing oxide at a temperature in the range of 200° C. or more and 320° C. or less.

12. A lithium-ion secondary battery comprising a positive electrode material mixture layer including the positive electrode active material for a lithium-ion secondary battery according to claim 1.
